(19) United States
(12) Patent Application Publication
(10) Pub. No.: US 2020/0205053 A1
(43) Pub. Date: Jun. 25, 2020

(54) ROUTING IN A MESH NETWORK

(71) Applicant: ASSA ABLOY AB, Stockholm (SE)

(72) Inventors: Fredrik ISAKSSON, Farsta (SE); Tomas JONSSON, Rönninge (SE); Per MACKEGÅRD, Solna (SE); Hardy BISMARK, Årsta (SE)

(21) Appl. No.: 16/609,941

(22) PCT Filed: May 2, 2018
(86) PCT No.: PCT/EP2018/061208

§ 371 Date: Oct. 31, 2019

(30) Foreign Application Priority Data
May 3, 2017 (SE) 1750537-1

(51) Int. Cl. H04W 40/24; H04W 40/04

(52) U.S. Cl. CPC H04W 40/246; H04W 84/18; H04W 40/04

(57) ABSTRACT

It is presented a method for determining a route for data in a mesh network. The method is performed in a mesh node of the mesh network and comprises the steps of: obtaining node data relating to other mesh nodes of the mesh network, the node data comprising a current energy level of the respective mesh node; obtaining a communication schedule, the communication schedule being based on Time Slotted Channel Hopping, TSCH; and determining at least part of a route through the mesh network to a gateway node based on the data relating to other mesh nodes.

### TECHNICAL FIELD

The invention relates to a method, a mesh node, a computer program and a computer program product for determining a route for data in a mesh network.

### BACKGROUND

Mesh networks have increased in popularity in recent years. In mesh networks, mesh nodes can function both as routing nodes and as a communication node, i.e. as a recipient or transmitter. ZigBee is one example of a known mesh network.

When the mesh nodes are battery powered, it is of utmost importance that the power consumption for routing is kept as low as possible.

### SUMMARY

It is an object to enable routing in a mesh network where power consumption is conserved.

According to a first aspect, it is presented a method for determining a route for data in a mesh network. The method is performed in a mesh node of the mesh network and comprises the steps of: obtaining node data relating to other mesh nodes of the mesh network, the node data comprising a current energy level of the respective mesh node; obtaining a communication schedule, the communication schedule being based on Time Slotted Channel Hopping, TSCH; and determining at least part of a route through the mesh network to a gateway node based on the data relating to other mesh nodes; wherein the method is repeated and when the step of determining at least part of a route results in a different route than before, a step of triggering redetermination is performed, comprising triggering redetermination of the communication schedule based on the most recent determining at least part of the route.

The step of determining the at least part of a route may be based also on the communication schedule.

The step of triggering redetermination of the communication schedule may comprise determining successive time slots in a cascade based on the route.

The step of determining at least part of a route may be based on a cost function which considers the node data.

The cost function may comprise a parameter of a number of hops to the gateway node.

The communication schedule may be a transmission schedule.

The communication schedule may be a reception schedule.

According to a second aspect, it is presented a mesh node for determining a route for data in a mesh network. The mesh node is configured to form part of a mesh network. The mesh node comprises: a processor; and a memory storing instructions that, when executed by the processor, cause the mesh node to: obtain node data relating to other mesh nodes of the mesh network, the node data comprising a current energy level of the respective mesh node; obtain a communication schedule, the communication schedule being based on Time Slotted Channel Hopping, TSCH; determine at least part of a route through the mesh network to a gateway node based on the data relating to other mesh nodes; repeat the mentioned instructions; and when the instructions to determine at least part of a route results in a different route than before, instructions to trigger redetermination are performed, comprising instructions that, when executed by the processor, cause the mesh node to trigger redetermination of the communication schedule based on the most recent determination of at least part of the route.

The instructions to determine the at least part of a route comprise instructions that, when executed by the processor, cause the mesh node to determine the at least part of a route also based on the communication schedule.

The instructions to trigger redetermination of the communication schedule may comprise instructions that, when executed by the processor, cause the mesh node to determine successive time slots in a cascade based on the route.

The instructions to determine at least part of a route may comprise instructions that, when executed by the processor, cause the mesh node to determine at least part of a route based on a cost function which considers the node data.

The cost function may comprise a parameter of a number of hops to the gateway node.

The communication schedule may be a transmission schedule.

The communication schedule may be a reception schedule.

According to a third aspect, it is presented an electronic lock comprising a mesh node according to the second aspect.

According to a fourth aspect, it is presented a computer program for determining a route for data in a mesh network, the mesh node being configured to form part of a mesh network. The computer program comprises computer program code which, when run on a mesh node causes the mesh node to: obtain node data relating to other mesh nodes of the mesh network, the node data comprising a current energy level of the respective mesh node; obtain a communication schedule, the communication schedule being based on Time Slotted Channel Hopping, TSCH; determine at least part of a route through the mesh network to a gateway node based on the data relating to other mesh nodes; repeat the mentioned computer program code; and when the computer program code to determine at least part of a route results in a different route than before, computer program code to trigger redetermination is performed to trigger redetermination of the communication schedule based on the most recent determination of at least part of the route.

According to a fifth aspect, it is presented a computer program product comprising a computer program according to the fourth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic drawing illustrating an environment in which embodiments presented herein can be applied;

FIG. 2 is a flow chart illustrating a method for determining a route for data in the mesh network of FIG. 1;

FIG. 3 is a schematic diagram illustrating components of any one of the mesh nodes of FIG. 1; and

FIG. 4 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

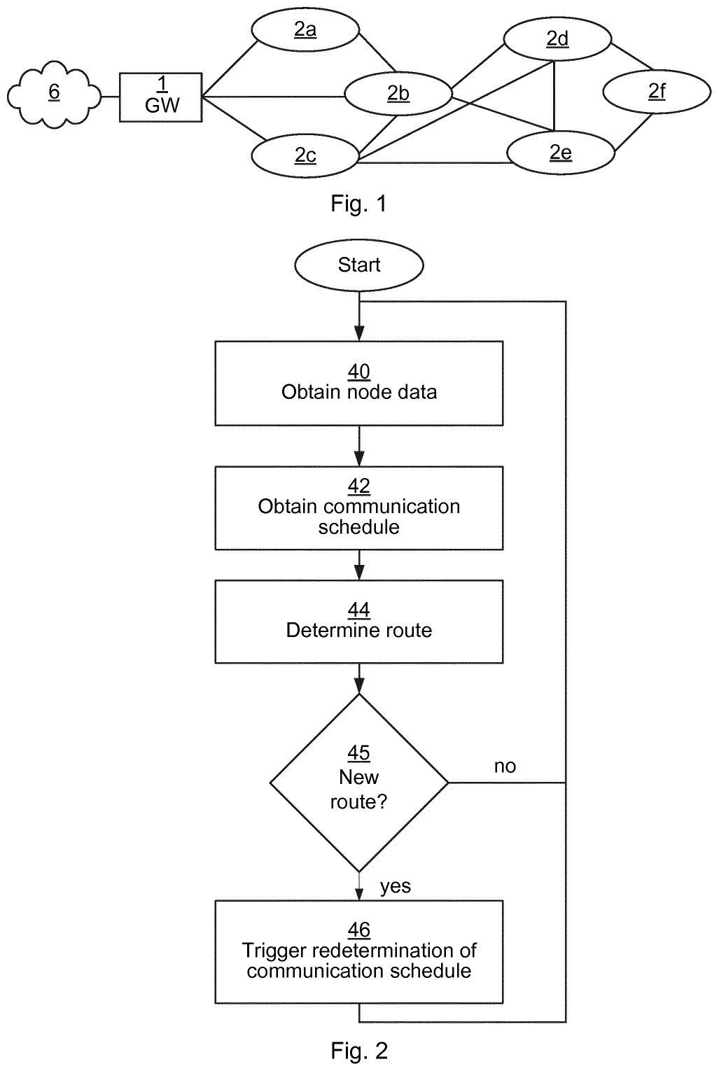

FIG. 1 is a schematic drawing illustrating an environment in which embodiments presented herein can be applied. It is shown a mesh network 8 comprising a gateway 1 and a number of mesh nodes 2a-f. The gateway 1 can also be considered to be a mesh node since it communicates with other mesh nodes 2a-f. Additionally, the gateway 1 communicates with a second network 6. The second network 6 can be wire based such as a local area network (LAN) e.g. based on Ethernet. Alternatively or additionally, the second network is wireless, e.g. based on any one or the IEEE 802.11 standards, Bluetooth, etc. The second network 6 optionally forms part of the Internet. Even though only one gateway 1 is shown in FIG. 1, additional gateways can optionally form part of the mesh network 8. While there are six mesh nodes 2a-f shown in FIG. 1, embodiments presented herein can be applied in mesh networks of any suitable number of mesh nodes.

Each one of the mesh nodes 2a-f can be an end point for a communication and can also function as a routing node. The determination of route through the mesh network 8 is described in more detail below. Each mesh node 2a-f can e.g. be an electronic lock, a sensor (for temperature, door/window position, an actuator, etc.).

While the mesh network is here represented in two dimensions, the mesh nodes can be provided as electronic locks in a three dimensional space, e.g. on different floors of a building such as a hotel. However, also in a three-dimensional space, the mesh network is based on links between mesh nodes in an analogy with what is presented in FIG. 1.

Another implementation of a mesh network is where different battery powered mesh nodes are provided in close proximity to each other and where the mesh nodes can take turns in assuming the role as a routing node. For instance, this can be applied in an environment around a single door, where there can be an electronic lock, a keypad on the outside, a keypad on the inside, a door sensor, etc.

FIG. 2 is a flow chart illustrating a method for determining a route for data in the mesh network of FIG. 1. The method is performed in any one or more of the mesh nodes of the mesh network.

In an obtain node data step 40, the mesh node obtains node data relating to other mesh nodes of the mesh network. The node data comprises a current energy level of the respective mesh node. The node data can be received as part of a mesh synchronisation, where the node data is propagated to throughout the mesh network. This mesh synchronisation can also include clock synchronisation, etc.

In an obtain communication schedule step 42, the mesh node obtains a communication schedule. The communication schedule is based on Time Slotted Channel Hopping, TSCH. The communication schedule can be obtained from a memory of the mesh node or by communicating with an external party, such as another mesh node or the gateway. The communication schedule can be a transmission schedule or a reception schedule.

In a determine route step 44, the mesh node determines at least part of a route through the mesh network to a gateway node based on the data relating to other mesh nodes. For instance, it can be avoided that mesh nodes with low current energy level (i.e. energy level at present) are used as routing nodes, since acting as a routing node results in higher energy consumption. In this way, mesh nodes will alternate in being routing nodes and energy levels across the mesh nodes will be evened out. Batteries of the mesh nodes can then be replaced concurrently, leading to more efficient maintenance of the mesh network and reduced risk of a single mesh node running out of batteries. It is to be noted that this routing can result in longer hops, reaching past an intermediate mesh node of low energy level, in order not to require routing tasks by the mesh node of low energy level.

The at least part of a route is optionally based also on the communication schedule.

In one embodiment, the at least part of a route is determined based on a cost function which considers the node data.

The cost function may comprise additional parameters. For instance, a parameter of a number of hops to the gateway node can be included to keep a number of hops low in order to keep latency low and to keep system energy consumption low (since each hop requires additional energy consumption). In one embodiment, a RSSI (Received Signal Strength Indication) parameter is included in the cost function such that links with low RSSI are avoided, all else equal. Links with low RSSI are likely to require more transmission energy and/or result in failed transmissions.

The determination of at least part of a route may comprise determining only the next hop from the mesh node or it may comprise determining an entire route to a specific destination (e.g. to the gateway).

In a conditional new route step 45, the mesh node evaluates whether step 44 results in a different route than before. If this is the case, the method proceeds to a trigger redetermination of communication schedule step 46. Otherwise, the method returns to the obtain node data step 40.

In the trigger redetermination of communication schedule step 46, the mesh node triggers redetermination of the communication schedule based on the most recent determining at least part of the route. The redetermination of the communication schedule can be performed by the mesh node performing the method or the redetermination can be performed by an external node. It is to be noted that it is still possible that the result of the redetermination could be to keep the communication schedule unchanged.

In one embodiment, the redetermination of communication schedule comprises determining successive time slots in a cascade based on the route. The cascade allows a sequence of transmissions to reach all mesh nodes in an efficient manner.

In one example, with reference to FIG. 1, a communication schedule is a transmission schedule with successive time slots in a cascade could be determined according to table 1:

TABLE 1
Transmission schedule in a time/frequency grid

| | Slot 1 | Slot 2 | Slot 3 | Slot 4 | Slot 5 | Slot 6 |
|---|---|---|---|---|---|---|
| Freq. 1 | 1 | | | | 2d | |
| Freq. 2 | | | 2d | | | 2c |
| Freq. 3 | | 2a | | | 2e | |
| Freq. 4 | | | 2e | | | |
| Freq. 5 | | 2b | | | | 2a |
| Freq. 6 | | | | 2f | | |
| Freq. 7 | | 2c | | | | 2b |

In Table 1, each row represents a different frequency band (e.g. different channel offsets) and each column represents a different time slot. The terms “time slot” and “slot” are equivalent in this description. In the grid, the to reference numeral (see FIG. 1) of the mesh node indicates that the corresponding mesh node is allowed to transmit. Time flows from left to right in the slots, such that a slot with a higher number occurs after a slot with a lower number. Slots 1 to 3 are used for efficient downlink communication, from the gateway 1 to more distant mesh nodes. Slots 4 to 6 are used for efficient uplink communication, from the most distant mesh node towards the gateway 1. When the schedule is not changed, the schedule is repeated, such that a new instance of slot 1 occurs after slot 6.

In accordance with Table 1, in slot 1, the gateway 1 can transmit. In slot 2, the first mesh node 2a, the second mesh node 2b and the third mesh nodes 2c can transmit. In slot 3, the fourth mesh node 2d and the fifth mesh node 2e can transmit. By providing the time slots in a cascading fashion in this way, any downlink signal (from the gateway to mesh nodes) from the network is propagated through the mesh network in a time efficient manner. For uplink (from mesh nodes towards the gateway), transmissions start in slot 4 for the sixth mesh node 2f. Slot 5 corresponds to slot 3 (but for uplink) and slot 6 corresponds to slot 2 (but for the uplink).

to Consider now a scenario where the battery power of the second mesh node 2b is low and a new route is determined where the second mesh node is not used as a routing node. In this scenario, the following links are inactivated: the link between the second mesh node 2b and the first mesh node 2a, the link between the second mesh node 2b and the third mesh node 2c, the link between the second mesh node 2b and the fourth mesh node 2d and the link between the second mesh node 2b and the fifth mesh node 2e. In other words, the second mesh node 2b only has a link with the gateway 1 to receive or transmit data.

The transmission schedule is then updated to again provide an efficient propagation of signals according to Table 2:

TABLE 2
Transmission schedule in a time/frequency grid where
the second mesh node is not a routing node

| | Slot 1 | Slot 2 | Slot 3 | Slot 4 | Slot 5 | Slot 6 |
|---|---|---|---|---|---|---|
| Freq. 1 | 1 | | | | 2d | |
| Freq. 2 | | | 2d | | | 2c |
| Freq. 3 | | | | | 2e | |
| Freq. 4 | | | 2e | | | |
| Freq. 5 | | | | | | 2a |
| Freq. 6 | | | | 2f | | |
| Freq. 7 | | 2c | | | | 2b |

Here, the second mesh node 2b is not active in slot 2, since no routing passes through the second mesh node 2b. Moreover, in slot 2, the first mesh node 2a does not need to transmit, since the second mesh node 2b can receive downlink data in slot 1 from the gateway 1. In the uplink, both the first mesh node 2a and the second mesh node 2b still need the ability to transmit data, whereby transmissions for these nodes 2a-b are still scheduled in slot 6.

Hence, whenever a new routing is determined in the mesh network, the communication schedule may need to be redetermined in order not to introduce delays in the network.

The example illustrated with tables 1 and 2 is related to transmission based scheduling, i.e. that the schedule defines what node(s) are allowed to transmit in each time slot. The communication schedule is then a transmission schedule. It is to be noted that embodiments presented herein can equally well be applied for reception based scheduling, when the schedule defines what node(s) are to listen to receive data in each time slot. In such an embodiment, the communication schedule is a reception schedule.

Using the presented method, routing in the mesh network is adjusted in accordance with current energy levels of mesh nodes. Moreover, all mesh nodes can be battery powered (except possibly the gateway) which greatly simplifies installation. The mesh network can operate in any suitable frequency band. Moreover, the TSCH provider great resilience to interference.

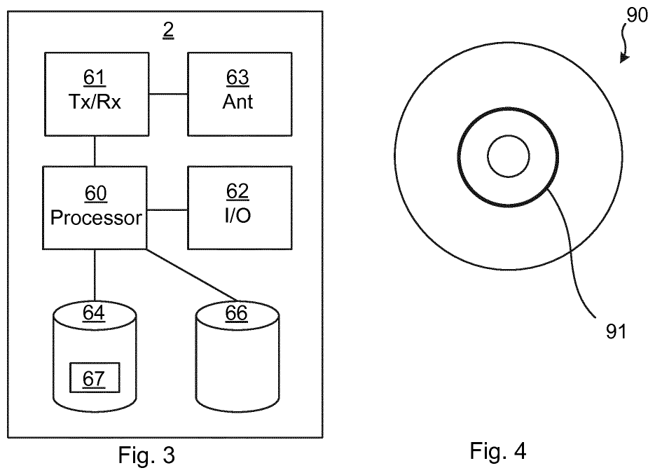

FIG. 3 is a schematic diagram illustrating components of any one of the mesh nodes 1, 2a-f, of FIG. 1, here represented by a single mesh node. A processor 60 is provided using any combination of one or more of a suitable central processing unit (CPU), multiprocessor, microcontroller, digital signal processor (DSP), application specific integrated circuit etc., capable of executing software instructions 67 stored in a memory 64, which can thus be a computer program product. The processor 60 can be configured to execute the method described with reference to FIG. 2 above.

The memory 64 can be any combination of random access memory (RAM) and read only memory (ROM). The memory 64 also comprises persistent storage, which, for example, can be any single one or combination of magnetic memory, optical memory, or solid-state memory.

A data memory 66 is also provided for reading and/or storing data during execution of software instructions in the processor 60. The data memory 66 can be any combination of random access memory (RAM) and read only memory (ROM).

The mesh node 2 further comprises an I/O (Input/Output) interface 62 for communicating with other entities.

A transceiver 61 comprises suitable analogue and digital components to allow signal transmission and signal reception with a wireless device using one or more antennas 63.

Other components of the mesh node 2 are omitted in order not to obscure the concepts presented herein.

FIG. 4 shows one example of a computer program product comprising computer readable means. On this computer readable means, a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 67 of FIG. 3. While the computer program 91 is here schematically shown as a track on the depicted optical disk, the computer program can be stored in any way which is suitable for the computer program product, such as a removable solid state memory, e.g. a Universal Serial Bus (USB) drive.

Here now follows a list of embodiments from another perspective, enumerated with roman numerals.

i. A method for determining a route for data in a mesh network, the method being performed in a mesh node of the mesh network and comprising the steps of:
obtaining node data relating to other mesh nodes of the mesh network, the node data comprising a current energy level of the respective mesh node;
obtaining a transmission schedule, the transmission schedule being based on Time Slotted Channel Hopping, TSCH; and
determining at least part of a route through the mesh network to a gateway node based on the data relating to other mesh nodes.

ii. The method according to embodiment i, wherein the step of determining the at least part of a route is based also on the transmission schedule.

iii. The method according to embodiment i or ii, wherein the method is repeated and when the step of determining at least part of a route results in a different route than before, a step of triggering redetermination is performed, comprising triggering redetermination of the transmission schedule based on the most recent determining at least part of the route.

iv. The method according to embodiment iii, wherein the step of triggering redetermination of the transmission schedule comprises determining successive time slots in a cascade based on the route.

v. The method according to any one of the preceding embodiments, wherein the step of determining at least part of a route is based on a cost function which considers the node data.

vi. The method according to embodiment v, wherein the cost function comprises a parameter of a number of hops to the gateway node.

vii. A mesh node for determining a route for data in a mesh network, the mesh node being configured to form part of a mesh network, the mesh node comprising:
a processor; and
a memory storing instructions that, when executed by the processor, cause the mesh node to:
obtain node data relating to other mesh nodes of the mesh network, the node data comprising a current energy level of the respective mesh node;
obtain a transmission schedule, the transmission schedule being based on Time Slotted Channel Hopping, TSCH; and
determine at least part of a route through the mesh network to a gateway node based on the data relating to other mesh nodes.

viii. The mesh node according to embodiment vii, wherein the instructions to determine the at least part of a route comprise instructions that, when executed by the processor, cause the mesh node to determine the at least part of a route also based on the transmission schedule.

ix. The mesh node according to embodiment vii or viii, further comprising instructions that, when executed by the processor, cause the mesh node to repeat the mentioned instructions and when the instructions to determine at least part of a route results in a different route than before, instructions to trigger redetermination are performed, comprising instructions that, when executed by the processor, cause the mesh node to trigger redetermination of the transmission schedule based on the most recent determination of at least part of the route.

x. The mesh node according to embodiment ix, wherein the instructions to step of triggering redetermination of the transmission schedule comprise instructions that, when executed by the processor, cause the mesh node to determine successive time slots in a cascade based on the route.

xi. The mesh node according to any one of embodiments vii to ix, wherein the instructions to determine at least part of a route comprise instructions that, when executed by the processor, cause the mesh node to determine at least part of a route based on a cost function which considers the node data.

xii. The mesh node according to any one of embodiments xi, wherein the cost function comprises a parameter of a number of hops to the gateway node.

xiii. An electronic lock comprising a mesh node according to any one of embodiments vii to xii.

xiv. A computer program for determining a route for data in a mesh network, the mesh node being configured to form part of a mesh network, the computer program comprising computer program code which, when run on a mesh node causes the mesh node to:
obtain node data relating to other mesh nodes of the mesh network, the node data comprising a current energy level of the respective mesh node;
obtain a transmission schedule, the transmission schedule being based on Time Slotted Channel Hopping, TSCH; and
determine at least part of a route through the mesh network to a gateway node based on the data relating to other mesh nodes.

xv. A computer program product comprising a computer program according to embodiment xiii and a computer readable means on which the computer program is stored.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method for determining a route for data in a mesh network, the method being performed in a mesh node of the mesh network and comprising the steps of:
obtaining node data relating to other mesh nodes of the mesh network, the node data comprising a current energy level of the respective mesh node;
obtaining a communication schedule, the communication schedule being based on Time Slotted Channel Hopping, TSCH; and
determining at least part of a route through the mesh network to a gateway node based on the data relating to other mesh nodes;
wherein the method is repeated and when the step of determining at least part of a route results in a different route than before, a step of triggering redetermination is performed, comprising triggering redetermination of the communication schedule based on the most recent determining at least part of the route and the step of triggering redetermination comprises determining successive time slots, in the communication schedule, in a cascade based on the route.

2. The method according to claim 1, wherein the step of determining the at least part of a route is based also on the communication schedule.

3. The method according to claim 1, wherein the step of determining at least part of a route is based on a cost function which considers the node data.

4. The method according to claim 3, wherein the cost function comprises a parameter of a number of hops to the gateway node.

5. The method according to claim 1, wherein the communication schedule is a transmission schedule.

6. The method according to claim 1, wherein the communication schedule is a reception schedule.

7. A mesh node for determining a route for data in a mesh network, the mesh node being configured to form part of a mesh network, the mesh node comprising:
a processor; and
a memory storing instructions that, when executed by the processor, cause the mesh node to:
obtain node data relating to other mesh nodes of the mesh network, the node data comprising a current energy level of the respective mesh node;
obtain a communication schedule, the communication schedule being based on Time Slotted Channel Hopping, TSCH;
determine at least part of a route through the mesh network to a gateway node based on the data relating to other mesh nodes;
repeat the mentioned instructions; and
when the instructions to determine at least part of a route results in a different route than before, instructions to trigger redetermination are performed, comprising instructions that, when executed by the processor, cause the mesh node to trigger redetermination of the communication schedule based on the most recent determination of at least part of the route, and cause the mesh node to determine successive time slots, in the communication schedule, in a cascade based on the route.

8. The mesh node according to claim 7, wherein the instructions to determine the at least part of a route comprise instructions that, when executed by the processor, cause the mesh node to determine the at least part of a route also based on the communication schedule.

9. The mesh node according to claim 7, wherein the instructions to determine at least part of a route comprise instructions that, when executed by the processor, cause the mesh node to determine at least part of a route based on a cost function which considers the node data.

10. The mesh node according to any one of claims 9, wherein the cost function comprises a parameter of a number of hops to the gateway node.

11. The mesh node according to claim 7, wherein the communication schedule is a transmission schedule.

12. The mesh node according to claim 7, wherein the communication schedule is a reception schedule.

13. An electronic lock comprising a mesh node according to claim 7.

14. A computer program for determining a route for data in a mesh network, the mesh node being configured to form part of a mesh network, the computer program comprising computer program code which, when run on a mesh node causes the mesh node to:
obtain node data relating to other mesh nodes of the mesh network, the node data comprising a current energy level of the respective mesh node;
obtain a communication schedule, the communication schedule being based on Time Slotted Channel Hopping, TSCH;
determine at least part of a route through the mesh network to a gateway node based on the data relating to other mesh nodes;
repeat the mentioned computer program code; and
when the computer program code to determine at least part of a route results in a different route than before, computer program code to trigger redetermination is performed to trigger redetermination of the communication schedule based on the most recent determination of at least part of the route and to determine successive time slots, in the communication schedule, in a cascade based on the route.

15. A computer program product comprising a computer program according to claim 14 and a computer readable means on which the computer program is stored.

16. (canceled)

17. (canceled)
